(19) United States
(12) Patent Application Publication
(10) Pub. No.: US 2026/0166593 A1
(43) Pub. Date: Jun. 18, 2026

(54) PUMP ARRANGEMENT OF A WORK APPARATUS

(71) Applicant: Andreas Stihl AG & Co. KG, Waiblingen (DE)

(72) Inventors: Fabian Broghammer, Rudersberg (DE); Christopher Tost, Auenwald (DE); Christian Krauer, Weinstadt (DE)

(21) Appl. No.: 19/421,955

(22) Filed: Dec. 16, 2025

(30) Foreign Application Priority Data
Dec. 16, 2024 (DE) 10 2024 138 100.0

(51) Int. Cl. B08B 3/02; F04B 53/16; F04B 53/22

(52) U.S. Cl. CPC B08B 3/02; F04B 53/22; F04B 53/16

(57) ABSTRACT

A pump arrangement of a liquid-conducting work apparatus, in particular a high-pressure cleaning device, has a pump for delivering the liquid, and a method is for installing such a pump arrangement. The pump arrangement includes a liquid connecting part, a first pump arrangement part and a second pump arrangement part, the first and the second pump arrangement parts being releasably connected to each other and in particular screwed together. The liquid connecting part is held between the first and the second pump arrangement parts with a form fit.

### CROSS-REFERENCE TO RELATED APPLICATIONS

This application claims priority of German patent application no. 10 2024 138 100.0, filed Dec. 16, 2024, the entire content of which is incorporated herein by reference.

### TECHNICAL FIELD

The disclosure relates to a pump arrangement of a liquid-conducting work apparatus and to a method for installing such a pump arrangement.

### BACKGROUND

Work apparatuses, for example in the form of a high-pressure cleaner, are equipped with a pump, via which water, a liquid cleaning agent or a mixture thereof is delivered. A corresponding pump arrangement includes at least one liquid connecting part and, as a rule, at least two pump arrangement parts connected releasably to each other. For example, tap water can be supplied via the liquid connecting part.

In a conventional configuration, such liquid connecting parts are integrated in an associated pump arrangement part by being formed in one piece with the metal housing of the corresponding pump arrangement part. A liquid-conducting line is connected or is connectable to the respective liquid connecting part. In the low-pressure suction example, such a line may be a water hose.

During operation, forces can be introduced into the liquid connecting part and the associated pump arrangement part via such a connected line. These parts are dimensioned to withstand the forces expected during correct operation. However, in everyday work, it is not possible to eliminate the occurrence of an overload situation due to inadvertent impact or due to other circumstances, in which the liquid connecting part and/or the associated pump arrangement part is damaged and possibly even breaks. Repair requires complex removal of the pump arrangement, replacement of the pump arrangement part, and re-installation which is no less complex.

### SUMMARY

It is an object of the disclosure to provide a pump arrangement such that it is less sensitive and is easier to repair.

This object is achieved by a pump arrangement according to various embodiments of the disclosure and by a method according to various embodiments of the disclosure.

According to the disclosure, it is provided that the liquid connecting part is held between the first and the second pump arrangement parts with a form fit. In particular, the first and the second pump arrangement parts bear against each other with a force fit being formed, while, outside the force fit, the liquid connecting part is held between the first and the second pump arrangement parts with a form fit, in particular exclusively with a form fit.

The installation and the removal according to the disclosure of the liquid connecting part are very simple because of the fixation principle according to the disclosure. The liquid connecting part has only to be inserted between the pump arrangement parts, whereupon the surrounding components, that is, the first and the second pump arrangement part, are then screwed together. The position of the liquid connecting part is defined and fixed by the two pump arrangement parts. The function is provided without other fixing elements. The separation of the liquid connecting part from the two pump arrangement parts and the connection between them only with a form fit has the effect that overload and damage to the liquid connecting part do not continue into the adjacent pump arrangement parts. Damage due to impact or the like remains locally limited to the liquid connecting part, which makes the pump arrangement less sensitive overall. Removal is undertaken very simply, analogously to the installation described above, and therefore easy repair is possible by simply replacing the liquid connecting part.

The robustness achieved by the disclosure is also increased in particular in that at least the first or the second pump arrangement part, in particular the first and the second pump arrangement parts, is/are made of metal, and in that the liquid connecting part is made of plastic. As a result, the liquid connecting part is significantly less resilient than the pump arrangement parts and therefore acts as a predetermined breaking point in the event of overload. It is ensured that, in the event of overload, only the easily replaceable and also cost-effective liquid connecting part is damaged and has to be replaced, while the adjacent pump arrangement parts remain undamaged.

In particular, the liquid connecting part has three form-fit elements for a form-fit connection to the first and/or to the second pump arrangement part, the three form-fit elements not lying on a common straight line. This makes it possible to easily fix the position of the liquid connecting part in all translational and rotational degrees of freedom in an exact, reproducible and highly resilient manner.

In particular, two form-fit elements are configured as coaxial pins. In particular, at least one of the two coaxial pins includes a liquid-conducting channel section. With a simple geometric configuration, the pins and their associated receptacles are highly resilient. In addition, with little outlay on construction and installation, apart from a pivoting movement about the common axis, they define all of the translational and rotational degrees of freedom. However, the last-mentioned degree of freedom can readily be defined by the third form-fit element, thus resulting in an overall clearly defined and highly resilient spatial fixing of the liquid connecting part with respect to the adjacent pump arrangement parts.

In particular, at least one of the two pump arrangement parts has a pin-shaped form, a form-fit element of the liquid connecting part being configured as a retaining ring surrounding the pin-shaped form. This creates a translational form fit which acts in all directions lying perpendicular to the axis of the pin-shaped form.

With installation and removal being easily possible, a high mechanical load-bearing capacity is produced. In addition, the rotational degree of freedom remaining in the two first and second form-fit elements described above can thereby be reliably defined.

In particular, at least one of the two pump arrangement parts has a pin-shaped form, the liquid connecting part having an, in particular integrally formed, support surface for support against the pin-shaped form. This enables a highly resilient support against lateral forces and also against resulting pivoting torques to be achieved.

The aforementioned pin-shaped form, in particular in a dual function, is also a screw eye for screwing together the two pump arrangement parts. This means that force is introduced from the liquid connecting part into the corresponding pump arrangement part in the immediate vicinity of the screw connection, without a force flow through other regions of the pump arrangement parts having to take place. The pump arrangement parts thus remain free in large regions of the loads which can be introduced by the liquid connecting part. This contributes to the robustness of the pump arrangement according to the disclosure.

### BRIEF DESCRIPTION OF DRAWINGS

The invention will now be described with reference to the drawings wherein:

FIG. 1 shows a perspective overview of a liquid-conducting work apparatus using the example of a high-pressure cleaning device having a pump arrangement and having a liquid connecting part;

FIG. 2 shows a perspective illustration of the pump arrangement of the high-pressure cleaning device according to FIG. 1 having a plurality of screwed-together pump arrangement parts and having a separate liquid connecting part held in between with a form fit;

FIG. 3 shows a perspective illustration of individual parts of the liquid connecting part according to FIG. 2 made of plastic with form-fit elements integrally formed in one piece thereon;

FIG. 4 shows a sectional illustration of the pump arrangement according to FIG. 2 having two form-fit elements, in the form of coaxial pins, of the liquid connecting part in form-fitting engagement in two corresponding receptacles of two pump arrangement parts bearing against each other with a force fit; and,

FIG. 5 shows a further sectional illustration of a region of the pump arrangement according to FIG. 2 having a form-fit element, in the form of a retaining ring, of the liquid connecting part and having a pin-shaped screw eye, which reaches through the retaining ring with a form fit, of one of the pump arrangement parts.

### DETAILED DESCRIPTION

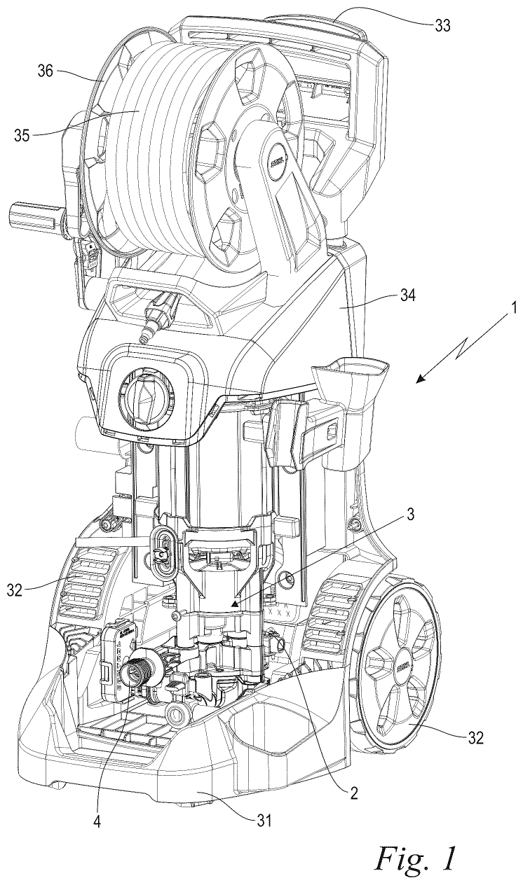

FIG. 1 shows a perspective overview of a work apparatus 1, which conducts a liquid during operation, using the example of a high-pressure cleaning device. The liquid is water, a liquid detergent and/or a mixture thereof.

In a lower region, the work apparatus 1 includes a pedestal 31 and two wheels 32, with which it stands on the ground during normal operation. In an upper region, there is arranged a handle 33, via which the work apparatus 1 can be carried or tilted to lift the pedestal 31 from the ground and can be moved on the wheels 32 to change position.

Extending between the lower pedestal 31 and the upper handle is a housing 34 from which a cover, not illustrated, has been removed for a better overview. In the housing 34 there is a pump arrangement 2 having a pump 3, not illustrated specifically, for delivering the liquid mentioned. The pump arrangement 2 also includes a liquid connecting part 4 for connecting a liquid-conducting line. In the embodiment shown, the liquid connecting part 4 is part of a low-pressure suction, for example for tap water, and thus serves for the connection of a fresh water line. However, the liquid connecting part 4 may also be a connecting part to a high-pressure outlet, a bypass connection, a connection for the supply of a chemical cleaning agent or the like.

During operation, the pump 3 delivers the liquid introduced via the liquid connecting part 4 and ejects it at a suitable location. For this purpose, in the example shown of the high-pressure cleaner, use is made of a pressure gun, not illustrated, or a pressure lance, likewise not illustrated, which is connected via a high-pressure hose 35 via a further liquid connecting part, likewise not illustrated, to the output side of the pump arrangement 2. The high-pressure hose 35 is wound up here on an optional hose reel 36.

The pump 3 is a high-pressure pump via which the cleaning liquid can be set at a pressure of at least 10 bar, in particular of at least 15 bar, in particular of at least 30 bar, in particular of at least 100 bar. In particular, with the pump 3, the liquid can be placed under a pressure of not more than 600 bar, in particular of not more than 500 bar.

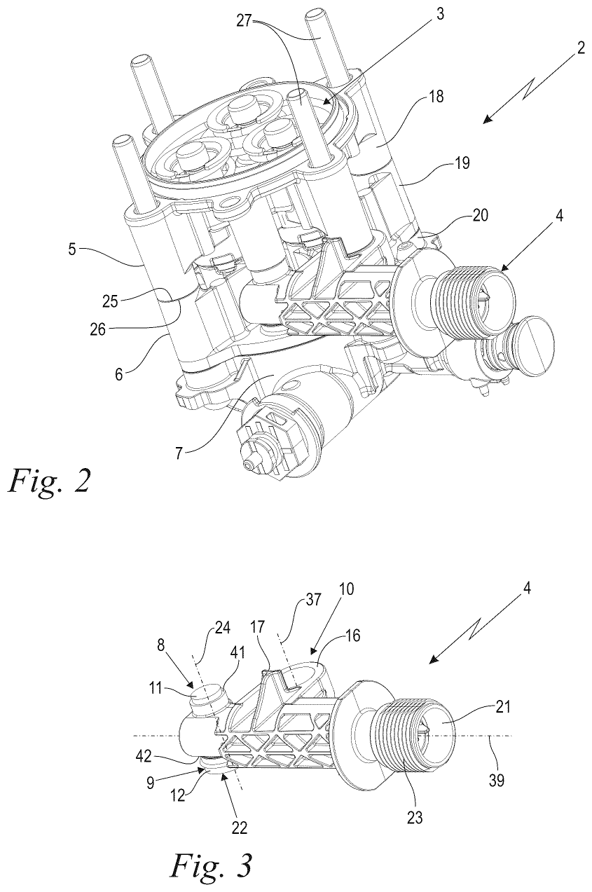

FIG. 2 shows a perspective illustration of the pump arrangement 2 of the high-pressure cleaning device 1 according to FIG. 1. In addition to the liquid connecting part 4 already mentioned, the pump arrangement 2 also includes at least two, here three, pump arrangement parts 5, 6, 7. The pump arrangement parts 5, 6, 7 include the pump 3, here in the form of a piston pump having three pistons, as well as a system, not shown specifically, of liquid channels and valves. However, the pump 3 may also be formed separately from the pump arrangement parts 5, 6, 7 as part of the pump arrangement 2 or more generally separately from the pump arrangement 2 as part of the work apparatus 1.

The pump arrangement parts 5, 6, 7 are stacked on top of each other and screwed together via continuous clamping bolts 27. The pump arrangement parts 5, 6, 7 each have screw eyes 18, 19, 20 for receiving the clamping bolts 27. In addition, they have mutually facing contact pressure surfaces 25, 26, via which, under the prestressing force of the clamping bolts 27 forming a force fit, they lie against each other with a force fit. The liquid connecting part 4 is held between the first and the second pump arrangement parts 5, 6 with a form fit, in a manner described in more detail below, outside this force fit, in particular outside the effective range of the force-fitting connection of the two pump arrangement parts 5, 6.

One of the pump arrangement parts 5, 6, between which the liquid connecting part 4 is held, or both thereof, may be made of plastic. For example, one of these pump arrangement parts may be a part of the housing 34 made of plastic (FIG. 1). In the embodiment shown, the pump arrangement parts 5, 6, 7 are made of metal, here of light metal casting. The liquid connecting part 4 is manufactured as an individual part separate therefrom. It may also be made of metal and in particular of light metal casting but, in the embodiment shown, is made of plastic.

FIG. 3 shows a perspective illustration of individual parts of the liquid connecting part 4 according to FIG. 2 having a liquid inlet 21 and having a liquid outlet 22. In the region of the liquid inlet 21, the liquid connecting part 4 is provided with an outer thread 23, onto which, for example, a hose connecting coupling for the connection of a hose for feeding in water can be screwed.

The liquid connecting part 4 extends along a longitudinal axis 39 and has a plurality of, here three, form-fit elements 8, 9, 10 for a form-fitting connection to the first and/or to the second pump arrangement part 5, 6. The three form-fit elements 8, 9, 10 are integrally formed in one piece on the liquid connecting part 4 which is manufactured from plastic. They do not lie on a common straight line. On the contrary, only two form-fit elements 8, 9 lie on a common axis 24, which here lies perpendicular to the longitudinal axis 39, while the third form-fit element 10 is positioned at a radial distance from the axis 24. As a result, the three form-fit elements 8, 9, 10 form a triangle that spans a plane. By this means, and by the form-fit, described in more detail further below, to the pump arrangement parts 5, 6, the liquid connecting part 4 is spatially fixed so that it cannot shift or twist with respect to the pump arrangement parts 5, 6 even under load.

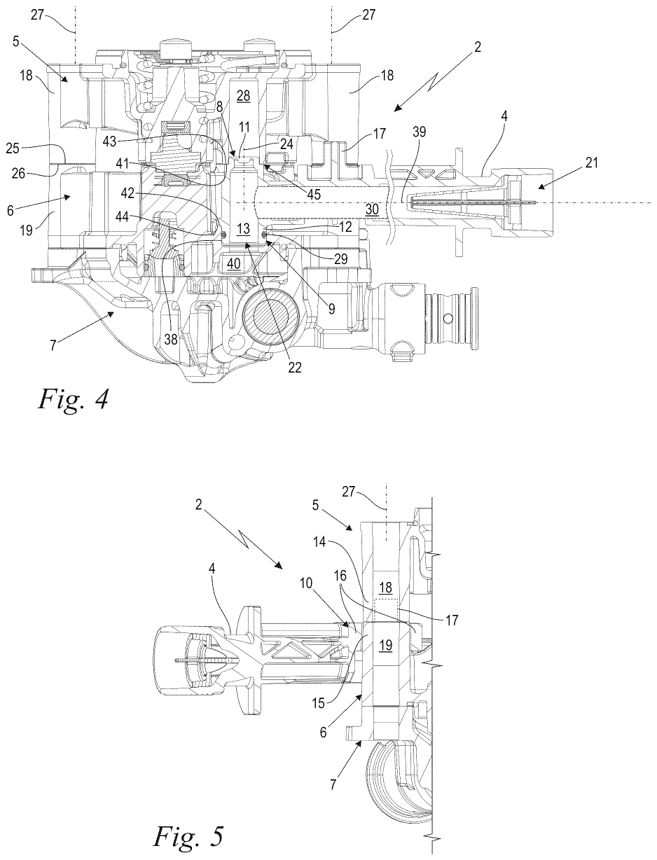

In the embodiment shown, two form-fit elements 8, 9 are configured as pins 11, 12 which are coaxial with respect to the axis 24. The two pins 11, 12 each have a stop surface 41, 42 acting in the axial direction, the stop surface 42 of the lower, second pin 12 not being visible here, but being illustrated in FIG. 4. The third form-fit element 10 of the liquid connecting part 4 is configured as a retaining ring 16 with a central, cylindrical ring opening, wherein an opening axis 37 of the ring opening lies parallel to the axis 24 of the two pins 11, 12. In addition, a collar-shaped support surface 17 facing the opening axis 37 is formed on the liquid connecting part 4 adjacent to the retaining ring 16 and its ring opening.

FIG. 4 shows a sectional illustration of the pump arrangement according to FIG. 2. In the upper, first pump arrangement part 5 there is formed a cross-sectionally cylindrical receiving dome 28 which is adapted in its diameter to the diameter of the upper pin 11 of the liquid connecting part 4 and surrounds the first form-fit element 8 in the form of the pin 11 with a form fit. Analogously, in the lower, second pump arrangement part 6 there is formed a cross-sectionally cylindrical pin receptacle 38 which is adapted in its diameter to the diameter of the lower pin 12 of the liquid connecting part 4 and surrounds the second form-fit element 9 in the form of the pin 12 with a form fit. The aforementioned form fit on the pins 11, 12 acts in all translational directions of a plane perpendicular to the axis 24. In addition, a collar-shaped circumferential stop 43, 44 of the receiving dome 28 and of the pin receptacle 38 lie opposite the axial stop surfaces 41, 42 of the pins 11, 12, as a result of which an axial, that is, a form-fitting, positional securing of the liquid connecting part 4 acting in the translational direction of the axis 24 is created at its two form-fit elements 8, 9.

Owing to their axial distance of the two pins 11, 12 to each other, they also create a rotationally acting form-fitting positional securing about all spatial axes perpendicular to the axis 24. In the region of the two pins 11, 12, that is, of the two first and second form-fit elements 8, 9, only a rotational degree of freedom about the axis 24 remains, which, however, is defined in the manner described below via the third form-fit element 10.

When the liquid connecting part 4 is mounted, the axis 24 lies parallel to the axis of the clamping bolts 27 and thus in their clamping direction. Between the upper stop surface 41 and the associated collar-shaped stop 43, a small but present distance 45 is left for creating an axial clearance. The axial form-fitting positional securing of the liquid connecting part in the region of the pins 11, 12 thus has a clearance in the direction of the axis 24 and thus also in the clamping direction of the clamping bolts 27 such that, although the clamping forces acting on the contact pressure surfaces 25, 26 have a force fit between the pump arrangement parts 5, 6 on their contact pressure surfaces 25, 26, the force fit and the clamping forces are not introduced into the liquid connecting part 4. This realizes the preferred proviso that, outside the force fit, the liquid connecting part 4 is held between the pump arrangement parts 5, 6, that is, in a manner free of clamping and with a form fit, between the first and the second pump arrangement parts 5, 6.

Within the scope of the disclosure, the selected term “outside the force fit with a form fit” also includes the possibility of dispensing with the axial clearance mentioned, with the introduction of only small axial clamping forces being able to be accepted as insignificant. Such clamping forces introduced into the liquid connecting part 4 in the region of the pins 11, 12 are considered to be low and thus as conforming with the aforementioned proviso, if they amount to not more than 10% of the clamping forces acting on the contact pressure surfaces 25, 26 of the force fit there. Within the scope of the disclosure, it is also possible to provide, in addition to the form-fitting retention, a force-fitting retention of the liquid connecting part 4 on one of the pump arrangement parts 5, 6, 7, for example in the form of clamping, but this force fit is then not the force fit between the pump arrangement parts 5, 6, 7.

It can also be gathered from the illustration according to FIG. 4 that channel sections 30, 13 are formed in the liquid connecting part 4. The first channel section 30 extends from the liquid inlet 21 in the direction of the longitudinal axis 39 to the region of the two pins 11, 12. The lower pin 12 includes a second channel section 13, which extends parallel to the axis 24, and into which the first channel section 30 leads. The second channel section 13 in turn leads into the liquid outlet 22 at the lower end of the pin 12, while the upper pin 11 is sealed liquid-tightly. The liquid outlet 22 is adjoined by a channel section 40, which is formed in the lower pump arrangement part 5, of a main line of the pump arrangement 2, which channel section leads to the pump 3 (FIGS. 1, 2), and which supplies the latter with the liquid supplied via the liquid connecting part 4. The lower, liquid-conducting pin 12 is provided on its outside with an O-ring 29, via which the pin 12 is sealed against the inside of the pin receptacle 38. The O-ring causes a clamping force flow between the lower pump arrangement part 5 and the liquid connecting part 4, which force flow lies is outside the force flow between the first and the second pump arrangement parts 5, 6, that is, is not influenced by it. In addition, the clamping effect of the O-ring is so low that the liquid connecting part 4 is held in the technical sense between the first and the second pump arrangement parts 5, 6 exclusively with a form fit.

FIG. 5 shows a further sectional illustration of the pump arrangement 2 according to FIG. 2 in the region of the form-fit element 10, which is configured as a retaining ring 16, of the liquid connecting part 4. At least one of the two pump arrangement parts 5, 6, between which the liquid connecting part 4 is held, has a pin-shaped form 14, 15. In the embodiment shown, the first and the second pump arrangement parts 5, 6 each have at least one, here a plurality of, pin-shaped forms 14, 15. The pin-shaped forms 14 of the first pump arrangement part 5 and the pin-shaped forms 15 of the second pump arrangement part 6 are also each configured as a screw eye 18, 19 for receiving the clamping screws 27 (FIG. 2) and for screwing the two pump arrangement parts 5, 6 together and with the third pump arrangement part 7.

It can be gathered from the sectional illustration according to FIG. 5 in conjunction with the perspective illustration according to FIGS. 2, 3 that the third form-fit element 10 in the form of the retaining ring 16 annularly surrounds one of the pin-shaped forms 14, 15, here a pin-shaped form 15 of the second pump arrangement part 6. This produces a form fit between the third form-fit element 10 and the second pump arrangement part 6, which form fit acts in a plane lying perpendicular to the axis 24. As a result, the above-described rotational degree of freedom of movement, which still remains in the region of the two pins 11, 12, of the liquid connecting part 4 about the axis 24, is defined. In addition, it follows from the overall view of FIGS. 4, 5 that the liquid connecting part 4 with its support surface 17 lies flat against one of the pin-shaped forms 14, 15, here against a pin-shaped form 14 of the first pump arrangement part 5. Overall, the liquid connecting part 4 is thus completely fixed in all translational and rotational degrees of freedom relative to the pump arrangement parts 5, 6 and can absorb all the operating forces introduced via connected lines or the like.

In addition, for the region of the third form-fit element 10 described here—as well as for the region of the first two form-fit elements 8, 9 described above in conjunction with FIG. 4—an exclusively form-fitting connection between the liquid connecting part 4 and the two adjacent pump arrangement parts 5, 6 is produced, without a force fit, in particular at the contact pressure surfaces 25, 26, playing a role.

In the event of overload, the liquid connecting part 4 acts as a predetermined breaking point and yields without the pump arrangement parts 5, 6, 7 being damaged. In the event of repair, according to a removal method according to the disclosure, only the clamping bolts 27 (FIG. 2) have to be released and the pump arrangement parts 5, 6 lifted from each other. This removes the form fit with the liquid connecting part 4. The damaged liquid connecting part 4 can be removed and replaced with a new one without the need for further complex removal or installation work. Conversely, in the installation method according to the disclosure, only a new liquid connecting part 4 has to be placed or positioned between the pump arrangement parts 5, 6 which are not yet connected to each other. Subsequently, the two pump arrangement parts 5, 6 are then releasably connected to each other, that is, screwed here, as a result of which the liquid connecting part 4 is then automatically held with a form fit between the first and the second pump arrangement parts 5, 6.

It is understood that the foregoing description is that of the preferred embodiments of the invention and that various changes and modifications may be made thereto without departing from the spirit and scope of the invention as defined in the appended claims.

1. A pump arrangement of a liquid-conducting work apparatus having a pump for delivering liquid, the pump arrangement comprising:
a liquid connecting part;
a first pump arrangement part and a second pump arrangement part releasably connected to each other; and,
said liquid connecting part being held between said first pump arrangement part and said second pump arrangement part with a form fit.

2. The pump arrangement of claim 1, wherein said first pump arrangement part and said second pump arrangement part bear against each other with a force fit being formed; and, outside said force fit, said liquid connecting part is held between said first pump arrangement part and said second pump arrangement part with the form fit.

3. The pump arrangement of claim 2, wherein said liquid connecting part is held between said first pump arrangement part and said second pump arrangement part exclusively with the form fit.

4. The pump arrangement of claim 1, wherein at least one of said first pump arrangement part and said second pump arrangement part is made of metal; and, said liquid connecting part is made of plastic.

5. The pump arrangement of claim 4, wherein said first pump arrangement part and said second pump arrangement parts are made of metal.

6. The pump arrangement of claim 1, wherein said liquid connecting part has three form-fit elements for a form-fit connection to at least one of said first pump arrangement part and said second pump arrangement part, said three form-fit elements not lying on a common straight line.

7. The pump arrangement of claim 6, wherein two of said three form-fit elements are coaxial pins.

8. The pump arrangement of claim 7, wherein at least one of said two coaxial pins include a channel section for conducting the liquid.

9. The pump arrangement of claim 1, wherein at least one of said first pump arrangement part and said second pump arrangement part has a pin-shaped form; and, a form-fit element of said liquid connecting part is a retaining ring surrounding said pin-shaped form.

10. The pump arrangement of claim 9, wherein said pin-shaped form is a screw eye for screwing together said first pump arrangement part and said second pump arrangement part.

11. The pump arrangement of claim 1, wherein at least one of said first pump arrangement part and said second pump arrangement part has a pin-shaped form; and, said liquid connecting part has a support surface for support against said pin-shaped form.

12. The pump arrangement of claim 10, wherein said support surface is formed in one piece.

13. The pump arrangement of claim 12, wherein said pin-shaped form is the screw eye for screwing together said first pump arrangement part and said second pump arrangement part.

14. The pump arrangement of claim 1, wherein the work apparatus is a high-pressure cleaning device.

15. The pump arrangement of claim 1, wherein said first pump arrangement part and said second pump arrangement part are screwed together.

16. A method for installing a pump arrangement of a liquid-conducting work apparatus having a pump for delivering liquid, the pump arrangement including a liquid connecting part, a first pump arrangement part and a second pump arrangement part, the first pump arrangement part and the second pump arrangement part being releasably interconnected, the method comprising:
holding the liquid connecting part between said first pump arrangement part and said second pump arrangement part with a form fit.
